(19) United States
(12) Patent Application Publication
(10) Pub. No.: US 2026/0294001 A1
(43) Pub. Date: Oct. 1, 2026

(54) AEROSOL PROVISION SYSTEM

(71) Applicant: Nicoventures Trading Limited, London (GB)

(72) Inventor: Jeremy CAMPBELL, London (GB)

(21) Appl. No.: 19/709,903

(22) Filed: Jun. 16, 2026

Related U.S. Application Data
(63) Continuation of application No. 18/725,872, filed on Dec. 20, 2022.

(30) Foreign Application Priority Data
Jan. 5, 2022 (GB) 2200039.2

(51) Int. Cl. A24F 40/53; A24F 40/42; A24F 40/51

(52) U.S. Cl. CPC A24F 40/53; A24F 40/42; A24F 40/51

(57) ABSTRACT

An aerosol provision system comprising a consumable, and an aerosol provision device which is configured to receive the consumable. The aerosol provision device comprises a receptacle for receiving the consumable. Also provided is a cover which is moveable between a first, closed, position in which the cover at least partially covers the receptacle, and a second, open, position in which the cover at least partially exposes the receptacle. A first portion, such as a light source or an aerosol generator, or a sensor, is configured to be controlled in response to there being a determination that the cover has moved to the second position. In this way, the first portion may be operated in response to the cover is determined as having been opened, to save power in the aerosol provision system by not operating the portion beforehand.

### PRIORITY CLAIM

The present application is a Continuation of US Application No. 18/725,872 filed Jul. 1, 2024, which is a National Phase entry of PCT Application No. PCT/GB2022/053312, filed Dec. 20, 2022, which claims priority from GB Application No. 2200039.2 filed Jan. 5, 2022, each of which hereby fully incorporated herein by reference.

### FIELD

The present disclosure relates to aerosol provision systems such as, but not limited to, nicotine delivery systems (e.g. electronic cigarettes and the like).

### BACKGROUND

Electronic aerosol provision systems often employ an electronic cigarette (e-cigarette) or more generally an aerosol provision device. Such an aerosol provision system typically contains aerosolisable material (also called aerosol-generating material), such as a reservoir of fluid or liquid containing a formulation, typically but not necessarily including nicotine, or a solid material such as a tobacco-based product, from which a vapour/aerosol is generated for inhalation by a user, for example through heat vaporisation. Thus, an aerosol provision system will typically comprise a vaporiser (also called an aerosol generator), e.g. a heating element, arranged to aerosolise a portion of aerosolisable material to generate a vapour.

Once a vapour has been generated, the vapour may be passed through flavouring material to add flavour to the vapour (if the aerosolisable material was not itself flavoured), after which the (flavoured) vapour may be then delivered to a user via a mouthpiece from the aerosol provision system. A potential drawback of existing aerosol provision systems and associated aerosol provision devices is that, and particularly for those with a visual impairment, and/or in conditions where visibility is reduced, it may not always be readily discernible as to a particular type of consumable which is going to be used as part of a particular use of the aerosol provision system.

Various approaches are therefore described herein which seek to help address or mitigate some of these issues, through the implementation of an aerosol provision system which implements a sensor to determine a predetermined property of any consumable (such as a composition of aerosol generating material inside the consumable) which is being proposed for use in the aerosol provisions system prior to the system generating any aerosol using this consumable.

Also described herein are aerosol provision systems that are capable of receiving a cartridge/consumable in a receptacle of an aerosol provision device from the aerosol provision system. The receptacle is configured to be covered when not in use by a cover, such that when the cover is moved to expose the receptacle, this movement of the cover may be detected to then trigger an operation of a portion of the aerosol provision system, such as an operation relating to the aerosol generator of the aerosol provision system, or an operation of a sensor which is configured to sense a portion of the consumable which is configured to be received in the receptacle. In this way, and through these operations being associated with the location/movement of the cover, the efficiency of the aerosol provision system may be increased.

### SUMMARY

According to a first aspect of certain embodiments there is provided an aerosol provision system for generating an aerosol, wherein the aerosol provision system comprises a consumable, and an aerosol provision device which is configured to receive the consumable;
a. wherein the aerosol provision device comprises a receptacle for receiving the consumable; and
b. wherein the aerosol provision device comprises a cover which is moveable between:
i. a first position in which the cover at least partially covers a first end of the receptacle for inhibiting the consumable from being inserted into the receptacle; and
ii. a second position in which the cover at least partially exposes the first end for allowing the consumable to be received by the aerosol provision device in the receptacle; and
c. wherein the aerosol provision system further compromises a first portion whose operation is configured to be controlled by the aerosol provision system, wherein the aerosol provision system is configured to:
i. determine that the cover has moved from the first position to the second position; and
ii. operate the first portion of the aerosol provision system in response to determining that the cover has moved to the second position.

According to a second aspect of certain embodiments there is provided an aerosol provision device for an aerosol provision system for generating an aerosol, wherein the aerosol provision device comprises:
a. a receptacle for receiving the consumable;
b. a cover which is moveable between:
i. a first position in which the cover at least partially covers a first end of the receptacle for inhibiting the consumable from being inserted into the receptacle; and
ii. a second position in which the cover at least partially exposes the first end for allowing the consumable to be received by the aerosol provision device in the receptacle; and
c. a first position whose operation is configured to be controlled by the aerosol provision device, wherein the aerosol provision device is configured to:
i. determine that the cover has moved from the first position to the second position; and
ii. operate the first portion of the aerosol provision device in response to determining that the cover has moved to the second position

According to a third aspect of certain embodiments there is provided a method of controlling the operation of a portion of an aerosol provision system, wherein the aerosol provision system comprises a consumable and an aerosol provision device, wherein the aerosol provision device comprises a receptacle for receiving the consumable, and wherein the method comprises:
a. moving a cover, from the aerosol provision system, from a first position in which the cover at least partially covers a first end of the receptacle and inhibits the consumable from being inserted into the receptacle, to a second position in which the cover at least partially exposes the first end for allowing the consumable to be received by the aerosol provision device inside the receptacle;
b. determining that the cover has moved to the second position; and
c. operating the first portion of the aerosol provision system in response to determining that the cover has moved to the second position.

### BRIEF DESCRIPTION OF THE DRAWINGS

Embodiments of the invention will now be described, by way of example only, with reference to the accompanying drawings, in which:

FIG. 1 schematically represents in perspective view an aerosol provision system comprising a cartridge and aerosol provision device (shown separated) in accordance with certain embodiments of the disclosure;

FIG. 2 schematically represents in exploded perspective view of components of the cartridge of the aerosol provision system of FIG. 1;

FIGS. 3A to 3C schematically represent various cross-section views of a housing part of the cartridge of the aerosol provision system of FIG. 1;

FIGS. 4A and 4B schematically represent a perspective view and a plan view of a dividing wall element of the cartridge of the aerosol provision system of FIG. 1;

FIGS. 5A to 5C schematically represent two perspective views and a plan view of a resilient plug of the cartridge of the aerosol provision system of FIG. 1;

FIGS. 6A and 6B schematically represent a perspective view and a plan view of a bottom cap of the cartridge of the aerosol provision system of FIG. 1;

FIG. 7 schematically represents an embodiment of aerosol provision system in accordance with certain embodiments of the disclosure.

FIG. 8A schematically represents an embodiment of aerosol provision system which comprises an aerosol provision device and a consumable/cartridge which itself comprises a portion which is configured to be sensed, in accordance with certain embodiments of the disclosure.

FIG. 8B schematically represents the embodiment of FIG. 8A, wherein the consumable is located in a receptacle of the aerosol provision device, in accordance with certain embodiments of the disclosure.

FIG. 8C schematically represents the embodiment of FIG. 8A, wherein the consumable is located in a receptacle of the aerosol provision device, and wherein the consumable is covered by a cover such to be encapsulated, in accordance with certain embodiments of the disclosure.

FIG. 9A schematically represents an embodiment of aerosol provision system which comprises an aerosol provision device and a consumable/cartridge which is configured to be at least partially located in a receptacle of the aerosol provision device, in accordance with certain embodiments of the disclosure.

FIG. 9B schematically represents the embodiment of FIG. 9A, wherein the consumable is at least partially located in a receptacle of the aerosol provision device, in accordance with certain embodiments of the disclosure.

FIG. 10A schematically represents an embodiment of aerosol provision system which comprises an aerosol provision device and a consumable/cartridge which is configured to be at least partially located in a receptacle of the aerosol provision device, and wherein the cartridge is configured to be inductively heated through comprising a susceptor in the cartridge, in accordance with certain embodiments of the disclosure.

FIG. 10B schematically represents the embodiment of FIG. 10A, wherein the consumable is at least partially located in a receptacle of the aerosol provision device, in accordance with certain embodiments of the disclosure.

### DETAILED DESCRIPTION

Aspects and features of certain examples and embodiments are discussed / described herein. Some aspects and features of certain examples and embodiments may be implemented conventionally and these are not discussed / described in detail in the interests of brevity. It will thus be appreciated that aspects and features of apparatus and methods discussed herein which are not described in detail may be implemented in accordance with any conventional techniques for implementing such aspects and features.

The present disclosure relates to non-combustible aerosol provision systems (such as an e-cigarette). According to the present disclosure, a “non-combustible” aerosol provision system is one where a constituent aerosolisable material of the aerosol provision system (or component thereof) is not combusted or burned in order to facilitate delivery to a user. Aerosolisable material, which also may be referred to herein as aerosol generating material or aerosol precursor material, is material that is capable of generating aerosol, for example when heated, irradiated or energized in any other way. The aerosolisable material may also be flavoured, in some embodiments.

Throughout the following description the term “e-cigarette” or “electronic cigarette” may sometimes be used, but it will be appreciated this term may be used interchangeably with an aerosol provision system. An electronic cigarette may also known as a vaping device or electronic nicotine delivery system (END), although it is noted that the presence of nicotine in the aerosolisable material is not a requirement.

In some embodiments, the aerosol provision system is a hybrid device configured to generate aerosol using a combination of aerosolisable materials, one or a plurality of which may be heated. In some embodiments, the hybrid device comprises a liquid or gel aerosolisable material and a solid aerosolisable material. The solid aerosolisable material may comprise, for example, tobacco or a non-tobacco product.

Typically, the (non-combustible) aerosol provision system may comprise a cartridge/consumable part and a body/reusable/aerosol provision device part, which is configured to releasably engage with the cartridge/consumable part.

The aerosol provision system may be provided with a means for powering a vaporiser therein, and there may be provided an aerosolisable material transport element for receiving the aerosolisable material that is to be vaporised. The aerosol provision system may also be provided with a reservoir for containing aerosolisable material, and in some embodiments a further reservoir for containing flavouring material for flavouring a generated vapour from the aerosol provision system.

In some embodiments, the vaporiser may be a heater/heating element capable of interacting with the aerosolisable material so as to release one or more volatiles from the aerosolisable material to form a vapour/aerosol. In some embodiments, the vaporiser is capable of generating an aerosol from the aerosolisable material without heating. For example, the vaporiser may be capable of generating a vapour/aerosol from the aerosolisable material without applying heat thereto, for example via one or more of vibrational, mechanical, pressurisation or electrostatic means.

In some embodiments, the substance to be delivered may be an aerosolisable material which may comprise an active constituent, a carrier constituent and optionally one or more other functional constituents.

The active constituent may comprise one or more physiologically and/or olfactory active constituents which are included in the aerosolisable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, theine, a vitamin such as B6 or B12 or C, melatonin, a cannabinoid, or a constituent, derivative, or combinations thereof. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, or mixtures thereof.

In some embodiments, the active constituent is an olfactory active constituent and may be selected from a "flavour" and/or "flavourant" which, where local regulations permit, may be used to create a desired taste, aroma or other somatosensorial sensation in a product for adult consumers. In some instances such constituents may be referred to as flavours, flavourants, flavouring material, cooling agents, heating agents, and/or sweetening agents. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavouring material (flavour) may comprise menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, colouring agents, preservatives, binders, fillers, stabilizers, and/or antioxidants.

As noted above, aerosol provision systems (e-cigarettes) may often comprise a modular assembly including both a reusable part (body – or aerosol provision device) and a replaceable consumable (cartridge) part. Devices conforming to this type of two-part modular configuration may generally be referred to as two-part devices. It is also common for electronic cigarettes to have a generally elongate shape. For the sake of providing a concrete example, certain embodiments of the disclosure described herein may comprise this kind of generally elongate two-part device employing consumable parts. However, it will be appreciated the underlying principles described herein may equally be adopted for other electronic cigarette configurations, for example modular devices comprising more than two parts, as devices conforming to other overall shapes, for example based on so-called box-mod high performance devices that typically have a more boxy shape.

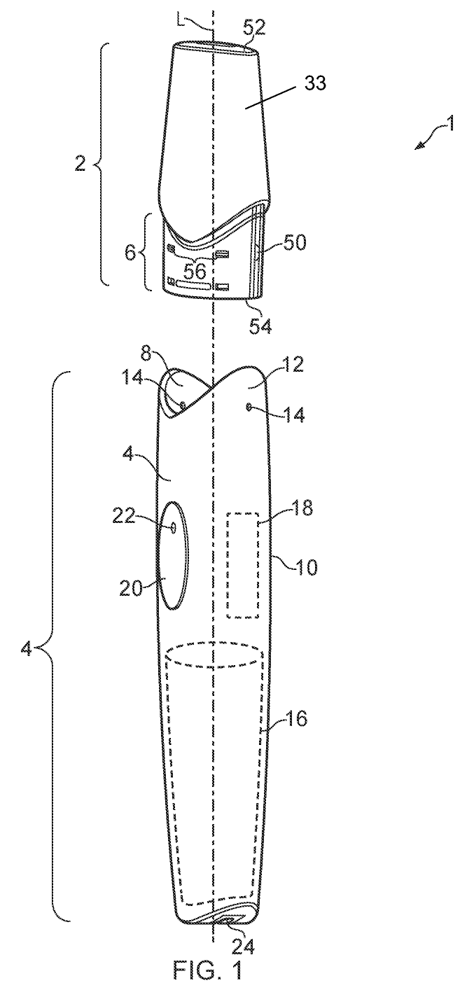

From the forgoing therefore, and with reference to FIG. 1 is a schematic perspective view of an example aerosol provision system (e-cigarette) 1 in accordance with certain embodiments of the disclosure. Terms concerning the relative location of various aspects of the electronic cigarette (e.g. terms such as upper, lower, above, below, top, bottom etc.) are used herein with reference to the orientation of the electronic cigarette as shown in FIG. 1 (unless the context indicates otherwise). However, it will be appreciated this is purely for ease of explanation and is not intended to indicate there is any required orientation for the electronic cigarette in use.

The e-cigarette 1 (aerosol provision system 1) comprises two main components, namely a cartridge 2 and an aerosol provision device 4. The aerosol provision device 4 and the cartridge 2 are shown separated in FIG. 1, but are coupled together when in use.

The cartridge 2 and aerosol provision device 4 are coupled by establishing a mechanical and electrical connection between them. The specific manner in which the mechanical and electrical connection is established is not of primary significance to the principles described herein and may be established in accordance with conventional techniques, for example based around a screw thread, bayonet, latched or friction-fit mechanical fixing with appropriately arranged electrical contacts / electrodes for establishing the electrical connection between the two parts as appropriate. For example electronic cigarette 1 represented in FIG. 1, the cartridge comprises a mouthpiece 33, a mouthpiece end 52 and an interface end 54 and is coupled to the aerosol provision device by inserting an interface end portion 6 at the interface end of the cartridge into a corresponding receptacle 8 / receiving section of the aerosol provision device. The interface end portion 6 of the cartridge is a close fit to be receptacle 8 and includes protrusions 56 which engage with corresponding detents in the interior surface of a receptacle wall 12 defining the receptacle 8 to provide a releasable mechanical engagement between the cartridge and the aerosol provision device. An electrical connection is established between the aerosol provision device and the cartridge via a pair of electrical contacts on the bottom of the cartridge (not shown in FIG. 1) and corresponding sprung contact pins in the base of the receptacle 8 (not shown in FIG. 1). As noted above, the specific manner in which the electrical connection is established is not significant to the principles described herein, and indeed some implementations might not have an electrical connection between the cartridge and a aerosol provision device at all, for example because the transfer of electrical power from the reusable part to the cartridge may be wireless (e.g. based on electromagnetic induction techniques).

The electronic cigarette 1 (aerosol provision system) has a generally elongate shape extending along a longitudinal axis L. When the cartridge is coupled to the aerosol provision device, the overall length of the electronic cigarette in this example (along the longitudinal axis) is around 12.5 cm. The overall length of the aerosol provision device is around 9 cm and the overall length of the cartridge is around 5 cm (i.e. there is around 1.5 cm of overlap between the interface end portion 6 of the cartridge and the receptacle 8 of the aerosol provision device when they are coupled together). The electronic cigarette has a cross-section which is generally oval and which is largest around the middle of the electronic cigarette and tapers in a curved manner towards the ends. The cross-section around the middle of the electronic cigarette has a width of around 2.5 cm and a thickness of around 1.7 cm. The end of the cartridge has a width of around 2 cm and a thickness of around 0.6 mm, whereas the other end of the electronic cigarette has a width of around 2 cm and a thickness of around 1.2 cm. The outer housing of the electronic cigarette is in this example is formed from plastic. It will be appreciated the specific size and shape of the electronic cigarette and the material from which it is made is not of primary significance to the principles described herein and may be different in different implementations. That is to say, the principles described herein may equally be adopted for electronic cigarettes having different sizes, shapes and / or materials.

The aerosol provision device 4 may in accordance with certain embodiments of the disclosure be broadly conventional in terms of its functionality and general construction techniques. In the example of FIG. 1, the aerosol provision device 4 comprises a plastic outer housing 10 including the receptacle wall 12 that defines the receptacle 8 for receiving the end of the cartridge as noted above. The outer housing 10 of the aerosol provision device 4 in this example has a generally oval cross section conforming to the shape and size of the cartridge 2 at their interface to provide a smooth transition between the two parts. The receptacle 8 and the end portion 6 of the cartridge 2 are symmetric when rotated through 180° so the cartridge can be inserted into the aerosol provision device in two different orientations. The receptacle wall 12 includes two aerosol provision device air inlet openings 14 (i.e. holes in the wall). These openings 14 are positioned to align with an air inlet 50 for the cartridge when the cartridge is coupled to the aerosol provision device. A different one of the openings 14 aligns with the air inlet 50 of the cartridge in the different orientations. It will be appreciated some implementations may not have any degree of rotational symmetry such that the cartridge is couplable to the aerosol provision device in only one orientation while other implementations may have a higher degree of rotational symmetry such that the cartridge is couplable to the aerosol provision device in more orientations.

The aerosol provision device further comprises a battery 16 for providing operating power for the electronic cigarette, control circuitry 18 for controlling and monitoring the operation of the electronic cigarette, a user input button 20, an indicator light 22, and a charging port 24.

The battery 16 in this example is rechargeable and may be of a conventional type, for example of the kind normally used in electronic cigarettes and other applications requiring provision of relatively high currents over relatively short periods. The battery 16 may be recharged through the charging port 24, which may, for example, comprise a USB connector.

The input button 20 in this example is a conventional mechanical button, for example comprising a sprung mounted component which may be pressed by a user to establish an electrical contact in underlying circuitry. In this regard, the input button may be considered an input device for detecting user input, e.g. to trigger aerosol generation, and the specific manner in which the button is implemented is not significant. For example, other forms of mechanical button or touch-sensitive button (e.g. based on capacitive or optical sensing techniques) may be used in other implementations, or there may be no button and the device may rely on a puff detector for triggering aerosol generation.

The indicator light 22 is provided to give a user with a visual indication of various characteristics associated with the electronic cigarette, for example, an indication of an operating state (e.g. on / off / standby), and other characteristics, such as battery life or fault conditions. Different characteristics may, for example, be indicated through different colours and / or different flash sequences in accordance with generally conventional techniques.

The control circuitry 18 is suitably configured / programmed to control the operation of the electronic cigarette to provide conventional operating functions in line with the established techniques for controlling electronic cigarettes. The control circuitry (processor circuitry) 18 may be considered to logically comprise various sub-units / circuitry elements associated with different aspects of the electronic cigarette's operation. For example, depending on the functionality provided in different implementations, the control circuitry 18 may comprises power supply control circuitry for controlling the supply of power from the battery/power supply to the cartridge in response to user input, user programming circuitry for establishing configuration settings (e.g. user-defined power settings) in response to user input, as well as other functional units / circuitry associated functionality in accordance with the principles described herein and conventional operating aspects of electronic cigarettes, such as indicator light display driving circuitry and user input detection circuitry. It will be appreciated the functionality of the control circuitry 18 can be provided in various different ways, for example using one or more suitably programmed programmable computer(s) and / or one or more suitably configured application-specific integrated circuit(s) / circuitry / chip(s) / chipset(s) configured to provide the desired functionality.

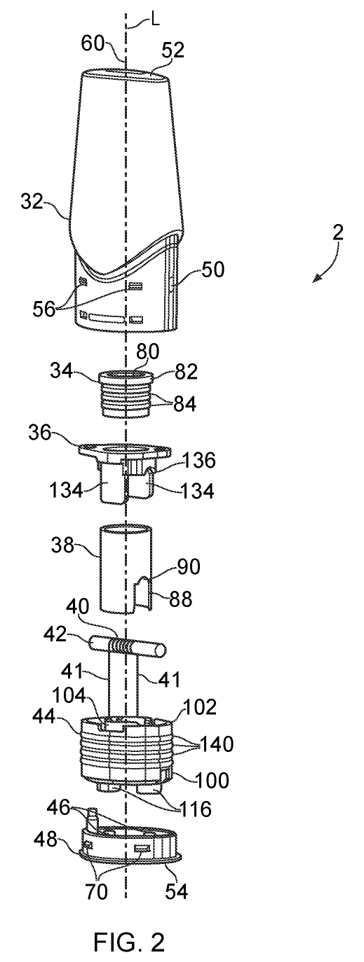

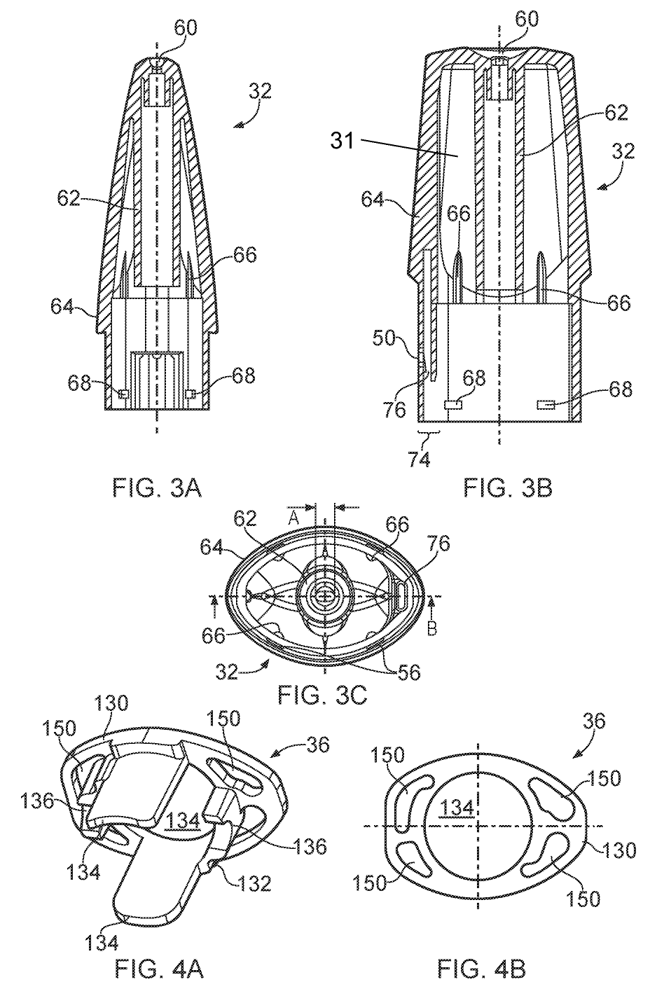

FIG. 2 is an exploded schematic perspective view of the cartridge 2 (exploded along the longitudinal axis L). The cartridge 2 comprises a housing part 32, an air channel seal 34, a dividing wall element 36, an outlet tube 38, a vaporiser/heating element 40, an aerosolisable material transport element 42, a plug 44, and an end cap 48 with contact electrodes 46. FIGS. 3 to 6 schematically represents some of these components in more detail.

FIG. 3A is a schematic cut-away view of the housing part 32 through the longitudinal axis L where the housing part 32 is thinnest. FIG. 3B is a schematic cut-away view of the housing part 32 through the longitudinal axis L where the housing part 32 is widest. FIG. 3C is a schematic view of the housing part along the longitudinal axis L from the interface end 54 (i.e. viewed from below in the orientation of FIGS. 3A and 3B).

FIGS. 4A is a schematic perspective view of the dividing wall element 36 as seen from below. FIG. 4B is a schematic cross-section through an upper part of the dividing wall element 36 as viewed from below.

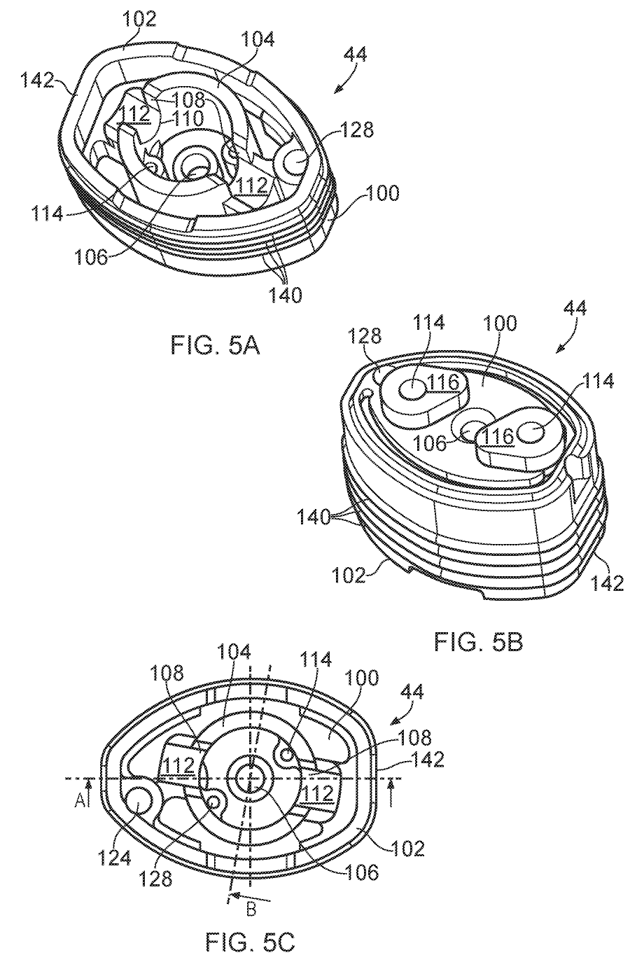

FIG. 5A is a schematic perspective view of the plug 44 from above and FIG. 5B is a schematic perspective view of the plug 44 from below. FIG. 5C is a schematic view of the plug 44 along the longitudinal axis L seen from the mouthpiece end 52 of the cartridge (i.e. viewed from above for the orientation in FIGS. 1 and 2).

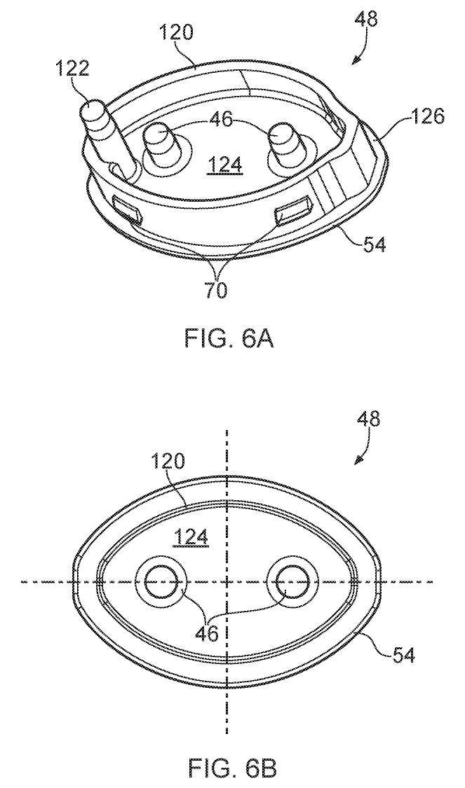

FIG. 6A is a schematic perspective view of the end cap 48 from above. FIG. 6B is a schematic view of the end cap 48 along the longitudinal axis L seen from the mouthpiece end 52 of the cartridge (i.e. from above).

The housing part 32 in this example comprises a housing outer wall 64 and a housing inner tube 62 which in this example are formed from a single moulding of polypropylene. The housing outer wall 64 defines the external appearance of the cartridge 2 and the housing inner tube 62 defines a part the air channel through the cartridge. The housing part is open at the interface end 54 of the cartridge and closed at the mouthpiece end 52 of the cartridge except for a mouthpiece opening / aerosol outlet 60, from the mouthpiece 33, which is in fluid communication with the housing inner tube 62. The housing part 32 includes an opening in a sidewall which provides the air inlet 50 for the cartridge. The air inlet 50 in this example has an area of around 2 mm². The outer surface of the outer wall 64 of the housing part 32 includes the protrusions 56 discussed above which engage with corresponding detents in the interior surface of the receptacle wall 12 defining the receptacle 8 to provide a releasable mechanical engagement between the cartridge and the aerosol provision device. The inner surface of the outer wall 64 of the housing part includes further protrusions 66 which act to provide an abutment stop for locating the dividing wall element 36 along the longitudinal axis L when the cartridge is assembled. The outer wall 64 of the housing part 32 further comprises holes which provide latch recesses 68 arranged to receive corresponding latch projections 70 in the end cap to fix the end cap to be housing part when the cartridge is assembled.

The outer wall 64 of the housing part 32 includes a double-walled section 74 that defines a gap 76 in fluid communication with the air inlet 50. The gap 76 provides a portion of the air channel through the cartridge. In this example the doubled-walled section 74 of the housing part 32 is arranged so the gap defines an air channel running within the housing outer wall 64 parallel to the longitudinal axis with a cross-section in a plane perpendicular to the longitudinal axis of around 3 mm². The gap / portion of air channel 76 defined by the double-walled section of the housing part extends down to the open end of the housing part 32.

The air channel seal 34 is a silicone moulding generally in the form of a tube having a through hole 80. The outer wall of the air channel seal 34 includes circumferential ridges 84 and an upper collar 82. The inner wall of the air channel seal 34 also includes circumferential ridges, but these are not visible in FIG. 2. When the cartridge is assembled the air channel seal 34 is mounted to the housing inner tube 62 with an end of the housing inner tube 62 extending partly into the through hole 80 of the air channel seal 34. The through hole 80 in the air channel seal has a diameter of around 5.8 mm in its relaxed state whereas the end of the housing inner tube 62 has a diameter of around 6.2 mm so that a seal is formed when the air channel seal 34 is stretched to accommodate the housing inner tube 62. This seal is facilitated by the ridges on the inner surface of the air channel seal 34.

The outlet tube 38 comprises a tubular section, for instance made of ANSI 304 stainless steel or polypropylene, with an internal diameter of around 8.6 mm and a wall thickness of around 0.2 mm. The bottom end of the outlet tube 38 includes a pair of diametrically opposing slots 88 with an end of each slot having a semi-circular recess 90. When the cartridge is assembled the outlet tube 38 mounts to the outer surface of the air channel seal 34. The outer diameter of the air channel seal is around 9.0 mm in its relaxed state so that a seal is formed when the air channel seal 34 is compressed to fit inside the outlet tube 38. This seal is facilitated by the ridges 84 on the outer surface of the air channel seal 34. The collar 80 on the air channel seal 34 provides a stop for the outlet tube 38.

The aerosolisable material transport element 42 comprises a capillary wick and the vaporiser (aerosol generator) 40 comprises a resistance wire heater wound around the capillary wick. In addition to the portion of the resistance wire wound around the capillary wick, the vaporiser comprises electrical leads 41 which pass through holes in the plug 44 to contact electrodes 46 mounted to the end cap 54 to allow power to be supplied to the vaporiser via the electrical interface the established when the cartridge is connected to an aerosol provision device. The vaporiser leads 41 may comprise the same material as the resistance wire wound around the capillary wick, or may comprise a different material (e.g. lower-resistance material) connected to the resistance wire wound around the capillary wick. In this example the heater coil 40 comprises a nickel iron alloy wire and the wick 42 comprises a glass fibre bundle. The vaporiser and aerosolisable material transport element may be provided in accordance with any conventional techniques and is may comprise different forms and / or different materials. For example, in some implementations the wick may comprise fibrous or solid a ceramic material and the heater may comprise a different alloy. In other examples the heater and wick may be combined, for example in the form of a porous and a resistive material. More generally, it will be appreciated the specific nature aerosolisable material transport element and vaporiser is not of primary significance to the principles described herein.

When the cartridge is assembled, the wick 42 is received in the semi-circular recesses 90 of the outlet tube 38 so that a central portion of the wick about which the heating coil is would is inside the outlet tube while end portions of the wick are outside the outlet tube 38.

The plug 44 in this example comprises a single moulding of silicone, may be resilient. The plug comprises a base part 100 with an outer wall 102 extending upwardly therefrom (i.e. towards the mouthpiece end of the cartridge). The plug further comprises an inner wall 104 extending upwardly from the base part 100 and surrounding a through hole 106 through the base part 100.

The outer wall 102 of the plug 44 conforms to an inner surface of the housing part 32 so that when the cartridge is assembled the plug in 44 forms a seal with the housing part 32. The inner wall 104 of the plug 44 conforms to an inner surface of the outlet tube 38 so that when the cartridge is assembled the plug 44 also forms a seal with the outlet tube 38. The inner wall 104 includes a pair of diametrically opposing slots 108 with the end of each slot having a semi-circular recess 110. Extended outwardly (i.e. in a direction away from the longitudinal axis of the cartridge) from the bottom of each slot in the inner wall 104 is a cradle section 112 shaped to receive a section of the aerosolisable material transport element 42 when the cartridge is assembled. The slots 108 and semi-circular recesses 110 provided by the inner wall of the plug 44 and the slots 88 and semi-circular recesses 90 of the outlet tube 38 are aligned so that the slots 88 in the outlet tube 38 accommodate respective ones of the cradles 112 with the respective semi-circular recesses in the outlet tube and plug cooperating to define holes through which the aerosolisable material transport element passes. The size of the holes provided by the semi-circular recesses through which the aerosolisable material transport element passes correspond closely to the size and shape of the aerosolisable material transport element, but are slightly smaller so a degree of compression is provided by the resilience of the plug 44. This allows aerosolisable material to be transported along the aerosolisable material transport element by capillary action while restricting the extent to which aerosolisable material which is not transported by capillary action can pass through the openings. As noted above, the plug 44 includes further openings 114 in the base part 100 through which the contact leads 41 for the vaporiser pass when the cartridge is assembled. The bottom of the base part of the plug includes spacers 116 which maintain an offset between the remaining surface of the bottom of the base part and the end cap 48. These spacers 116 include the openings 114 through which the electrical contact leads 41 for the vaporiser pass.

The end cap 48 comprises a polypropylene moulding with a pair of gold-plated copper electrode posts 46 mounted therein.

The ends of the electrode posts 44 on the bottom side of the end cap are close to flush with the interface end 54 of the cartridge provided by the end cap 48. These are the parts of the electrodes to which correspondingly aligned sprung contacts in the aerosol provision device 4 connect when the cartridge 2 is assembled and connected to the aerosol provision device 4. The ends of the electrode posts on the inside of the cartridge extend away from the end cap 48 and into the holes 114 in the plug 44 through which the contact leads 41 pass. The electrode posts are slightly oversized relative to the holes 114 and include a chamfer at their upper ends to facilitate insertion into the holes 114 in the plug where they are maintained in pressed contact with the contact leads for the vaporiser by virtue of the plug.

The end cap has a base section 124 and an upstanding wall 120 which conforms to the inner surface of the housing part 32. The upstanding wall 120 of the end cap 48 is inserted into the housing part 32 so the latch projections 70 engage with the latch recesses 68 in the housing part 32 to snap-fit the end cap 48 to the housing part when the cartridge is assembled. The top of the upstanding wall 120 of the end cap 48 abuts a peripheral part of the plug 44 and the lower face of the spacers 116 on the plug also abut the base section 124 of the plug so that when the end cap 48 is attached to the housing part it presses against the resilient part 44 to maintain it in slight compression.

The base portion 124 of the end cap 48 includes a peripheral lip 126 beyond the base of the upstanding wall 112 with a thickness which corresponds with the thickness of the outer wall of the housing part at the interface end of the cartridge. The end cap also includes an upstanding locating pin 122 which aligns with a corresponding locating hole 128 in the plug to help establish their relative location during assembly.

The dividing wall element 36 comprises a single moulding of polypropylene and includes a dividing wall 130 and a collar 132 formed by projections from the dividing wall 130 in the direction towards the interface end of the cartridge. The dividing wall element 36 has a central opening 134 through which the outlet tube 38 passes (i.e. the dividing wall is arranged around the outlet tube 38). In some embodiments, the dividing wall element 36 may be integrally formed with the outlet tube 38. When the cartridge is assembled, the upper surface of the outer wall 102 of the plug 44 engages with the lower surface of the dividing wall 130, and the upper surface of the dividing wall 130 in turn engages with the projections 66 on the inner surface of the outer wall 64 of the housing part 32. Thus, the dividing wall 130 prevents the plug from being pushed too far into the housing part 32 - i.e. the dividing wall 130 is fixedly located along the longitudinal axis of the cartridge by the protrusions 66 in the housing part and so provides the plug with a fixed surface to push against. The collar 132 formed by projections from the dividing wall includes a first pair of opposing projections / tongues 134 which engage with corresponding recesses on an inner surface of the outer wall 102 of the plug 44. The protrusions from the dividing wall 130 further provide a pair of cradle sections 136 configured to engage with corresponding ones of the cradle sections 112 in the part 44 when the cartridge is assembled to further define the opening through which the aerosolisable material transport element passes.

When the cartridge 2 is assembled an air channel extending from the air inlet 50 to the aerosol outlet 60 through the cartridge is formed. Starting from the air inlet 50 in the side wall of the housing part 32, a first section of the air channel is provided by the gap 76 formed by the double-walled section 74 in the outer wall 64 of the housing part 32 and extends from the air inlet 50 towards the interface end 54 of the cartridge and past the plug 44. A second portion of the air channel is provided by the gap between the base of the plug 44 and the end cap 48. A third portion of the air channel is provided by the hole 106 through the plug 44. A fourth portion of the air channel is provided by the region within the inner wall 104 of the plug and the outlet tube around the vaporiser 40. This fourth portion of the air channel may also be referred to as an aerosol/aerosol generation region, it being the primary region in which aerosol is generated during use. The air channel from the air inlet 50 to the aerosol generation region may be referred to as an air inlet section of the air channel. A fifth portion of the air channel is provided by the remainder of the outlet tube 38. A sixth portion of the air channel is provided by the outer housing inner tube 62 which connects the air channel to the aerosol outlet 60, which is located at an end of the mouthpiece 33. The air channel from the aerosol generation region to be the aerosol outlet may be referred to as an aerosol outlet section of the air channel.

Also, when the cartridge is assembled a reservoir 31 for aerosolisable material is formed by the space outside the air channel and inside the housing part 32. This may be filled during manufacture, for example through a filling hole which is then sealed, or by other means. The specific nature of the aerosolisable material, for example in terms of its composition, is not of primary significance to the principles described herein, and in general any conventional aerosolisable material of the type normally used in electronic cigarettes may be used. The present disclosure may refer to a liquid as the aerosolisable material, which as mentioned above may be a conventional e-liquid. However, the principles of the present disclosure apply to any aerosolisable material which has the ability to flow, and may include a liquid, a gel, or a solid, where for a solid a plurality of solid particles may be considered to have the ability to flow when considered as a bulk.

The reservoir is closed at the interface end of the cartridge by the plug 44. The reservoir includes a first region above the dividing wall 130 and a second region below the dividing wall 130 within the space formed between the air channel and the outer wall of the plug. The aerosolisable material transport element (capillary wick) 42 passes through openings in the wall of the air channel provided by the semi-circular recesses 108, 90 in the plug 44 and the outlet tube 38 and the cradle sections 112, 136 in the plug 44 and the dividing wall element 36 that engage with one another as discussed above. Thus, the ends of the aerosolisable material transport element extend into the second region of the reservoir from which they draw aerosolisable material through the openings in the air channel to the vaporiser 40 for subsequent vaporisation.

In normal use, the cartridge 2 is coupled to the aerosol provision device 4 and the aerosol provision device activated to supply power to the cartridge via the contact electrodes 46 in the end cap 48. Power then passes through the connection leads 41 to the vaporiser 40. The vaporiser is thus electrically heated and so vaporises a portion of the aerosolisable material from the aerosolisable material transport element in the vicinity of the vaporiser. This generates aerosol in the aerosol generation region of the air path. Aerosolisable material that is vaporised from the aerosolisable material transport element is replaced by more aerosolisable material drawn from the reservoir by capillary action. While the vaporiser is activated, a user inhales on the mouthpiece end 52 of the cartridge. This causes air to be drawn through whichever aerosol provision device air inlet 14 aligns with the air inlet 50 of the cartridge (which will depend on the orientation in which the cartridge was inserted into the aerosol provision device receptacle 8). Air then enters the cartridge through the air inlet 50, passes along the gap 76 in the double-walled section 74 of the housing part 32, passes between the plug 44 and the end cap 48 before entering the aerosol generation region surrounding the vaporiser 40 through the hole 106 in the base part 100 of the plug 44. The incoming air mixes with aerosol generated from the vaporiser to form a condensation aerosol, which is then drawn along the outlet tube 38 and the housing part inner 62 before exiting through the mouthpiece outlet/aerosol outlet 60 for user inhalation.

From the above FIGS. 1-6B, it can be seen a possible embodiment construction of aerosol provision system 1 which is configured for generating an aerosol, which is suitable for use in the context of the present disclosure (alongside potentially other forms of aerosol provision system).

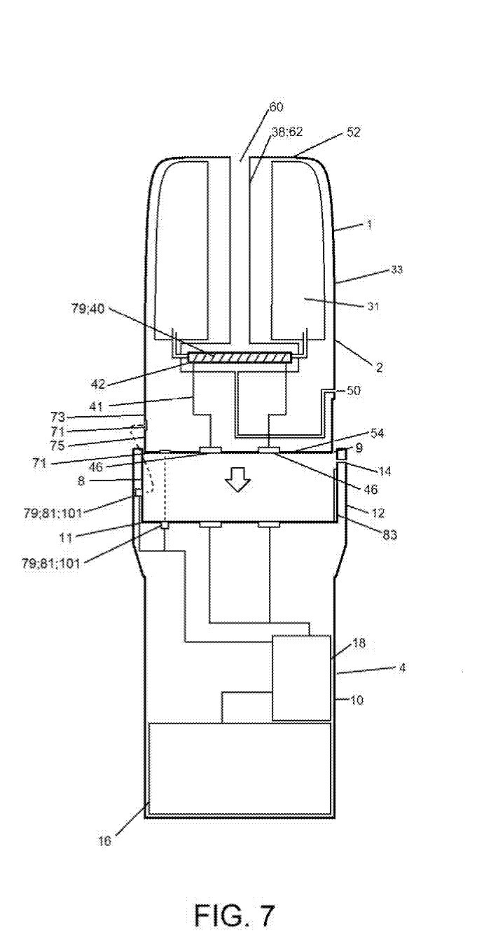

Turning now to FIGS. 7-10B, the present disclosure also provides for other applications and embodiments of aerosol provision system 1 which may complement those embodiments of aerosol provision system illustrated and described above with reference to FIGS. 1-6B.

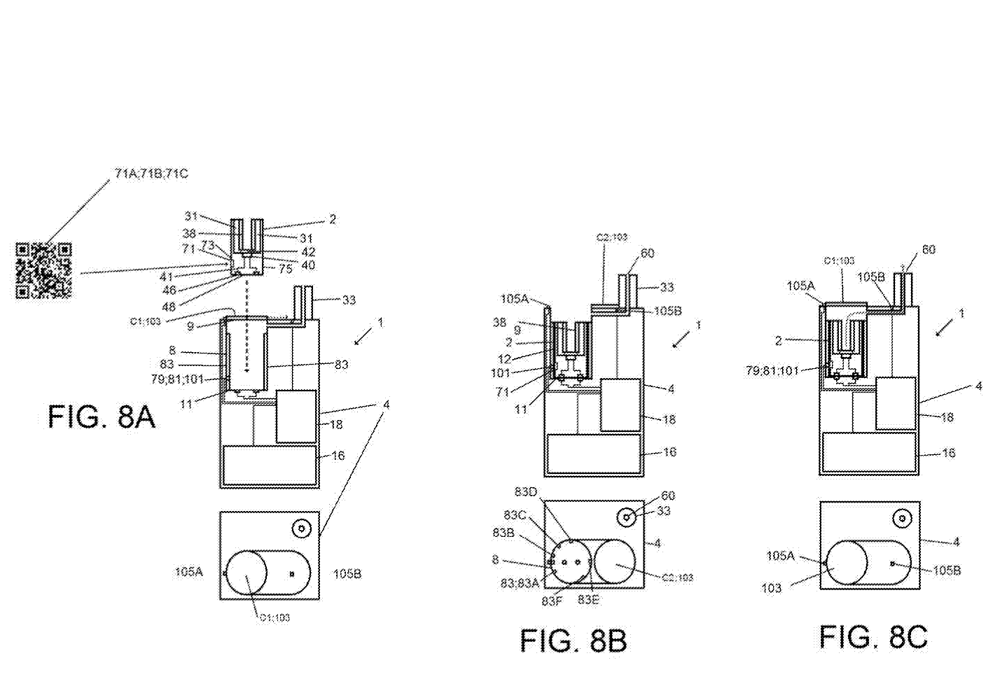

Thus with initial reference to FIGS. 7-8C, there is provided in accordance with some embodiments an aerosol provision system 1 for generating an aerosol, wherein the aerosol provision system 1 comprises a consumable 2, and an aerosol provision device 4 which is configured to receive the consumable 2. Although not necessarily, the consumable 2 may be related in structure and function to any of the cartridge/consumables described previously. Similarly, the aerosol provision device / control unit 4 may be related in structure and function to any of the aerosol provision device / control units described previously.

In accordance with these embodiments, the aerosol provision device 4 may comprise a sensor 101 for sensing a portion 71 of the consumable 2 when the consumable 2 is received by the aerosol provision device 4. In this way, the sensor 101 may be configured to output sensor data, and the aerosol provision device 4 may be configured to use the sensor data to determine a predetermined property of the consumable 2.

Thus at a general level therefore, an application of these embodiments is to facilitate the aerosol provision system 1, and/or the aerosol provision device 4, in being able to identify a property of the consumable 2 in advance of any operation of the consumable 2.

It is to be appreciated that at a general level, a variety of different sensor arrangements may be employed to sense the portion 71 of the consumable 2, depending on the nature of the portion 71. For instance, and in accordance with some embodiments, such as the embodiment from FIG. 7A, the sensor 101 may comprise an optical sensor, such as a camera in a very particular embodiment.

With the sensor 101 therefore, this may be configured to sense the portion 71 of the consumable 2 when the consumable 2 is received by the aerosol provision device 4. As to the nature of the portion 71, in accordance with some embodiments, the portion may comprise an external surface 73 of the consumable 2, such as an external surface of a base 75 of the consumable 2 in accordance with some particular embodiments.

Particularly in embodiments where the sensor 101 then comprises an optical sensor, the portion 71 in accordance with some embodiments may then comprise an appropriate appearance for allowing this portion 71 to be sensed. In this respect therefore, and in accordance with some embodiments, the portion may comprises an indicia 71A, a pattern 71B; a bar code; and/or a QR code 71C (as shown in the embodiment of FIG. 8A). At a more general level, the portion 71 in accordance with some embodiments may thus be machine-readable.

To facilitate the sensing of the portion 71 during use, and to avoid the portion 71 otherwise occupying too much space on the consumable 2, it has been found that the portion 71 may in accordance with some comprise a maximum dimension which is no more than 30m; a maximum dimension which is no more than 20mm in accordance with some narrower embodiments; a maximum dimension which is no more than 15mm in yet narrower embodiment; and/or a maximum dimension which is no more than 10mm in some yet narrower embodiments. By the term ‘maximum dimension’ here, this means that none of the maximum length/width/thickness of the portion 71 must be more than the quoted amount in millimetres.

Where the portion 71 is employed, as noted above the portion 71 may comprise an external surface 73 of the consumable 2, or be located on such an external surface 73 of the consumable 2, such as via the portion 71 comprising a label which may be attached to the consumable, such as to the external surface 73 of the consumable 2, and/or such as to form the external surface 73 of the consumable 2.

The exact location of the portion 71 may appreciably be varied about a surface of the consumable 2 as required, such as in the embodiments illustrated in FIG. 7 where the portion 71 is shown as potentially being located at the interface end 54 of the consumable 2, and/or at the base 75 of the consumable 2.

Whatever the location of the portion 71 however, the function of the portion 71 may be improved in so far as the aerosol provision device 4, and/or the aerosol provision system 1 is configured such that the portion 71 faces, and/or is exposed to, and/or is readable by, the sensor 101 when the consumable 2 is received by the aerosol provision device 4.

To assist with the above, in accordance with some embodiments, the aerosol provision device 4 in accordance with some embodiments may comprise a receptacle 8 which is configured to receive the consumable 2. In accordance with some embodiments thereof, the receptacle 8 may comprise a first end 9 for inserting the consumable 2 into the receptacle 8, and a second end 11 opposite the first end 9. In this way, the receptacle may then comprise a side wall 12 (receptacle wall) between the first end 9 and the second end 11.

Where such a receptacle 8 is employed, to better shield the sensor in use from accidental damage, the sensor 101 in accordance with some embodiments may be recessed into the side wall 12 and/or the second end 11, as shown for instance in the embodiments from FIG. 7 and 8A-8C.

Whatever the location of the sensor 101 however, and in so far as a sensor 101 is employed, as noted previously the sensor 101 may be configured to output sensor data, for allowing the aerosol provision device 4 to use the sensor data to determine a predetermined property of the consumable 2. As to what this predetermined property might be, appreciably this may be a number of different things. For instance, in accordance with some embodiments, the predetermined property may comprise a composition of aerosol generating material inside the consumable 2, and/or the predetermined property may comprise a remaining amount of aerosol generating material inside the consumable (which could be a solid, liquid, and/or a gel aerosol generating material, as required, depending on the embodiment of consumable being used). In this way, and is so far as the predetermined property may be then determined, the aerosol provision device 4 and/or the aerosol provision system 1 may be configured to take appropriate action in response to this determination. For instance, in accordance with a very particular embodiment, in response to determining a predetermined property of the consumable 2, the aerosol provision device 4 may be configured to selected a predetermined power profile or predetermined power setting for the aerosol generator 40 (e.g. to cater for a particular flavour, or amount, of aerosol generating material in the consumable 2). The predetermined property in accordance with some embodiments may appreciably alternatively/additionally comprise an indication on whether the consumable is authorised (or legitimate). In this way, the aerosol provision device may be configured to prevent the operation of the aerosol generator 40 from the aerosol provision device 4 until the aerosol provision system 1 has determined the predetermined property of the consumable 2, and/or until the aerosol provision system 1 has determined that the consumable 2 is authorised. This may be particularly helpful to help prevent any inadvertent damage to the aerosol provision device 4 from otherwise attempting to generate an aerosol from a counterfeit consumable, or from some other form of inferior consumable 2 which is not legitimate. These embodiments may also be helpful in so far as they can better prevent any inadvertent burning of the flavour(s) of the aerosol generating material, through applying an inappropriate heating regime to a particular flavour of aerosol generating material.

For better protecting the consumable 2, and any employed sensor 101, in use in accordance with some embodiments, and in so far as a receptacle 8 may be employed, in accordance with some embodiments, the receptacle 8 may configured to fully encapsulate the consumable 2 when the consumable 2 is received by the aerosol provision device, as shown for instance in the embodiment of FIGS. 8A-8C. To assist with this protection, in accordance with some embodiments, the aerosol provision system 1 may additionally/alternatively comprise a cover 103 which is moveable between a first position C1 in which the cover 103 at least partially covers the first end 9 of the receptacle 8 and inhibits the consumable 2 from being inserted into (or removed from) the receptacle 2; and a second position C2 in which the cover 103 at least partially exposes the first end 9 of the receptacle 8 for allowing the consumable 2 to be received by (or removed from) the aerosol provision device 4.

In so far as the cover 103 may be employed, the cover may in accordance with some embodiments be detachable from the aerosol provision device 4. This may be achieved, for instance, by way of the cover 103 (which could also be described as a cap, in such embodiments) being able to realisably attach to the aerosol provision device 4, such as in a very particular embodiment via a screw thread and/or via an interference fit. In accordance with some embodiments, the cover 103 may be configured to plug the first end 8 of the receptacle in the first position C1. In some embodiments however, as shown in the embodiment of FIGS. 8A-8C, the aerosol provision device 4 may comprise the cover 103.

As to how any employed cover 103 may move between the first position C1 and the second position C2, in accordance with some embodiments, the cover 103 may be slideable from the first position to the second position, such as per the embodiments shown in FIGS. 8A-8C, 9A-9B, and FIGS. 10A-10B. Appreciably however, in accordance with some embodiments, any employed cover 103 may be configured to rotate between the first position C1 and the second position C2, and/or perform some other movement(s) between the first position C1 and the second position C2

From the foregoing therefore, in so far as a cover 103 may be employed, this may serve to better protect some of the components of the aerosol provision system, such as any inside the receptacle 8, and particularly whilst the aerosol provision system 1 is not in use, such as per the positions from the embodiments of FIGS. 8A, 9A and 10A.

Though where the cover 103 is employed, a potential further application for the cover 103 is such that the aerosol provision device 4 may be configured to control an operation of the sensor (or more generally some other portion/component 79 of the aerosol provision device 4, as will be described) in response to determining that the cover 103 has moved: i) between the first position C1 and the second position C2; ii) from the first position C1 to the second position C2; and/or iii) from the second position C2 to the first position C1.

For instance, in accordance with some embodiments, the aerosol provision device 4 may be configured to operate the sensor 101 in response to the cover 103 being (determined as being) located in the second position C2. In this way, and in accordance with some related embodiments, the aerosol provision device may be configured to operate the sensor 101 whilst the cover 103 is in the second position C2, and/or may be configured to disable the sensor in response to the cover being located in the first position C1. Thus in accordance with these instances, the position of the cover 103 may be determinative on the operation of the sensor 101 (or more generally some other portion/component of the aerosol provision device 4), which may thus facilitate preserving the power of the aerosol provision device 4 to only power the sensor 101 (or other portion/component 79, such as the aerosol generator 40, or a light source 81 inside the receptacle 8) at times when the sensor (or other component) is expected to be operated.

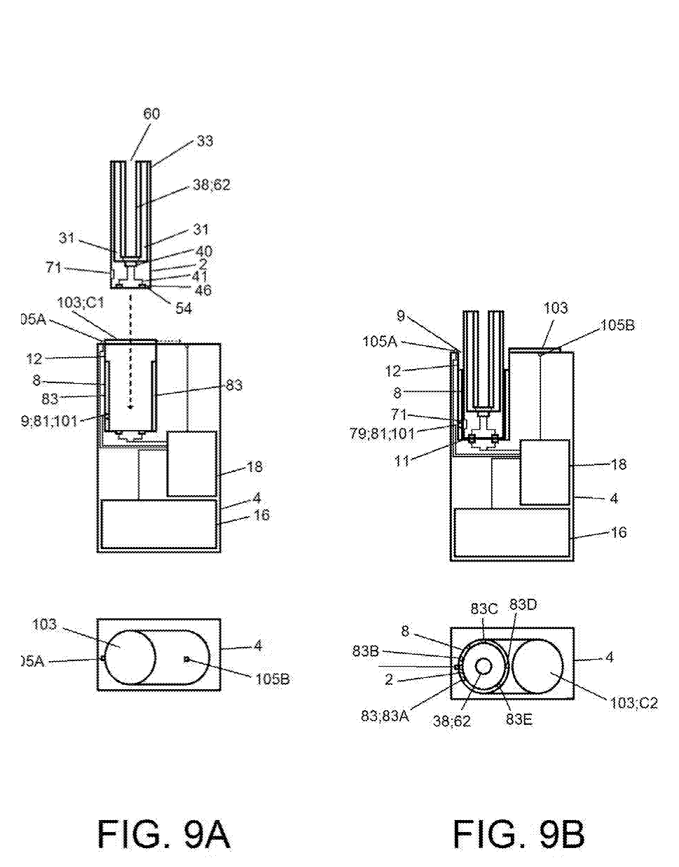

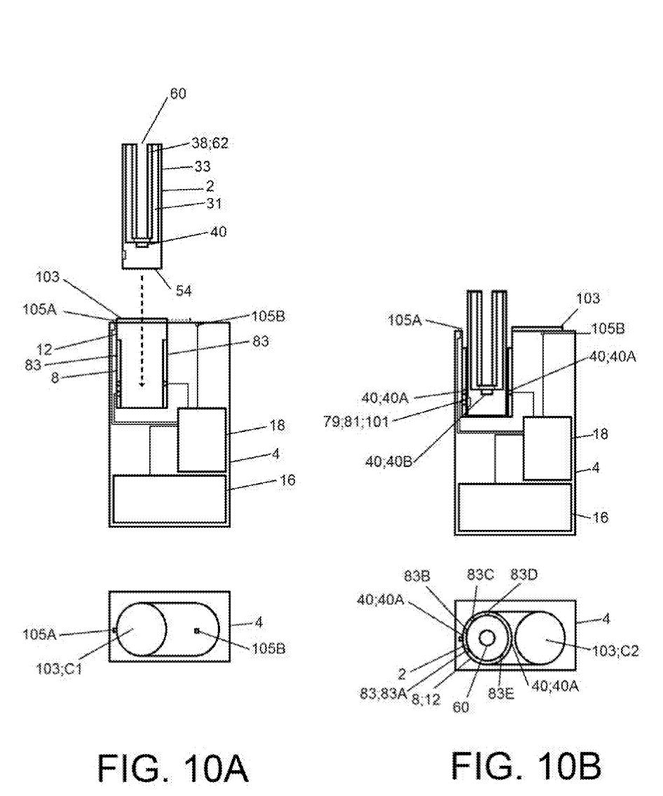

As an example therefore, and in so far as the aerosol provision device 4 may be configured to operate the sensor 101 in response to the cover 103 being located in the second position C2, this may thus allow the sensor 101 to be activated in time for when a user may then insert a consumable 2 into the receptacle 8, e.g. as shown in the position from FIGS. 8B, 9C, or FIG. 10B.

As another example, the aerosol provision device 4 may be configured to operate the aerosol generator 40 in response to the cover 103 being located in the second position C2.

In yet another example, the aerosol provision device 4 may be configured to operate a light source 81 in the receptacle in response to the cover 103 being located in the second position C2. In this way, the operation of the light source 81 may facilitate the user in being able to see where/how exactly the consumable 2 is to be inserted into the receptacle 8.

For the sake of completeness, the aerosol provision device 4 may be configured to operate any portion(s) 79 or component of the aerosol provision device 4 in response to the cover 103 being located in the second position C2, such that this functionality of the aerosol provision device 4 and aerosol provisions system 1 may be employed irrespective of whether or not the above noted sensor 101 and/or portion 71 is employed.

Mindful of the above disclosure, it will be appreciated that where a portion 79 of the component of the aerosol provision device 4 is configured to be operated based on the position of the cover 103, any such operation may be immediate, or in some embodiments could be operated after a predetermined time has elapsed following the aerosol provision system 1 (or aerosol provision device 4) determining that the cover 103 has moved to the relevant position.

For instance, and in accordance with some embodiments, the aerosol provision system 1 may be configured to operate the portion 79 of the aerosol provision system (whether this portion be, for instance the aerosol generator 40, the above noted light source 81, and/or the sensor 101 where this is employed), in response to determining that the cover has moved to the second (or first) position C2, after a predetermined time has elapsed following the aerosol provision system determining that the cover 103 has moved from the first position C1 to the second position C2 (or from the second position to the first position). With respect to some embodiments, the predetermined time may comprise at least 0.5 seconds; 0.7 seconds; 1 second; 1.5 seconds; 2 seconds; 3 seconds; 4 seconds; and/or 5 seconds. In this way, and taking an example where the portion being operated is the aerosol generator 40 or any employed sensor 101, the introduction of the time delay (predetermined time) may thus allow for the fact that it may take the user a period of time from opening the cover 103 to then place a consumable 2 in the receptacle 8. Thus to account for this delay, the provision of the time delay (predetermined time) may thus reduce battery consumption of the aerosol provision device 4 from not unnecessarily powering the portion 79 of the aerosol provision system during this time period whilst the user has yet to insert the consumable 2 into the receptacle 8.

In a similar way, and in accordance with some embodiments, the predetermined time may comprise no more than 20 seconds; no more than 15 seconds; no more than 12 seconds; no more than 10 seconds; no more than 8 seconds; no more than 7 seconds; and/or no more than 5 seconds in accordance with some embodiments. With the provision of this maximum timer period therefore, this may place a suitable upper bound on the time delay - by which time a user might be well expected to have placed a consumable 2 in the receptacle 8.

In some embodiments however, such as where the aerosol provision device 2 comprises a light source 81 in the receptacle (for helping the user to see in the receptacle 8), the provision of a time delay may be unnecessary, such that in accordance with some embodiments, the aerosol provision system (or aerosol provision device 4) may be configured to immediately operate the portion 79 of the aerosol provision system (such as the light source), i.e. without a time delay, in response to determining that the cover has moved to the second position C2.

With respect to the positioning of the above noted portion 79 (whether this be, for instance, the aerosol generator 40; a light source 81; or the sensor 101) of the aerosol provision device 4, to help protect the portion 79 in use, in accordance with some embodiments, the portion 79 may be located at the side wall, and/or towards or at the at the second end 11 of the receptacle 8. In accordance with some more particular embodiments, the portion 79 may be located no more than 30mm; no more than 25mm; no more than 20mm; no more than 15mm; and/or no more than 10mm, from the second end 11 of the receptacle 8. In this way, several advantages may be provided, not least from a perspective of better locating the portion 79 away from the first end 9 of the receptacle (where the portion 79 may otherwise be vulnerable to damage). Indeed though, and where the portion 79 comprises a light source 81, having this light source proximal the second end 11 may assist the user being able to see right into this end of the receptacle 8, and may also provide an element of discretion in better shrouding the light from the light source to be contained within the receptacle 8. As well, and where the portion 79 comprises the sensor 101, having this sensor 101 proximal the second end 11 may assist with the accuracy of the sensor to not sense the consumable 8 unless the consumable has been fully inserted into the receptacle 8, as opposed to half-inserted or inserted incorrectly.

For further protecting the portion 79, and for facilitating the insertion of the consumable 2 into the receptacle, the receptacle 8 (and/or the consumable 2) may be substantially cylindrical.

Relating to the retaining of the consumable 2 in the receptacle 8 in use, this retaining may be facilitated in accordance with some embodiments through the aerosol provision device 4 comprising at least one retaining portion 83, or a plurality of retaining portions 83A-83F, for gripping the consumable 2 received in the receptacle 8. In accordance with some embodiments, and where a plurality of retaining portions 83A-83F is provided, the plurality of retaining portions 83A-83F may be configured to surround the consumable, and/or more in particular embodiments, grip a plurality of different circumferential portions of the consumable 2 received in the receptacle 8.

In accordance with some embodiments, to assist with the gripping of the consumable 2, and to provide improve strength to the each of the retaining portions 83, each retaining portion may project into the receptacle 8, such as through each retaining portion projecting from the side wall 12 of the receptacle 8 (as shown in the embodiments of FIGS. 7-10B).

In so far as any retaining portion 83 is employed, the gripping effect of the retaining portion may be better distributed about the consumable, such to better prevent any damage to the consumable 2 in accordance with some embodiments, through each retaining portion extending between the first end 9 and the second end 11 of the receptacle 8, and in some more particular embodiments by each retaining portion extending at least 50%; 60%; 70%; 80%; and/or at least 90% of a distance between the first end 9 and the second end 11 of the receptacle 8. A distance of at least 70% here has been found to demonstrate particularly beneficial gripping.

Where any retaining portions 83 are employed, these retaining portions 83 may also serve in some embodiments to also protect the portion 79 from inadvertent damage. This may be achieved through said portion(s) 79 (such as any of the aerosol generator 40; any light source 81; and/or or the sensor 101) being located between the plurality of retaining portions 83.

With respect to any portion 79 potentially comprising the aerosol generator 40, it will be appreciated therefore that any employed aerosol generator 40 need not necessarily be located as part of the consumable 2. In this respect for instance, and in accordance with some embodiments, the aerosol provision device 4 may comprise the aerosol generator 40. For instance, and in accordance with some embodiments, the aerosol generator 40 may be located in the receptacle 8, and/or may comprise a tubular aerosol generator 40 which is configured to at least partially surround the consumable 2 when the consumable is received by the aerosol provision device 4 in the receptacle. In this way, and when the aerosol generator 40 is then operated, the aerosol generator 40 (which could for instance comprise a heating element), may then aerosolise the aerosol generating material in the consumable (e.g. via heat transmitted from the [potentially tubular] heating element from the aerosol provision device 4 to the aerosol generating material in the consumable 2).

In accordance with some embodiments, the aerosol provision system 1 may comprise an inductive or wireless heating arrangement for generating the aerosol from the aerosol generating material, as shown for instance in the embodiment of FIGS. 10A-10B. In accordance with such embodiments, the aerosol provision device 4 and/or the receptacle 8 may comprise a coil 40A which is configured to inductively heat a susceptor 40B located in the consumable, wherein the susceptor 40B is configured to heat the aerosol generating material in the consumable 2 to generate the aerosol. In this way, the aerosol generator may comprise the susceptor 40B

Whatever form of aerosol generator 40 is employed, it may be appreciated moving back to the cover 103 that in some embodiments, the operation of the aerosol generator 40, or indeed any other portion 79 of the aerosol provision device or aerosol provision system may be controlled based on a determined position of the cover 103. For effecting this determination, it may be appreciated that a number of different arrangements may be employed, such as by using an appropriate form of sensor or detection circuit which can sense or determine the position of the cover 103. A particular embodiment is illustrated in the embodiments of FIGS. 8A-10B for completeness. In this particular embodiment, the aerosol provision device 4 comprises a first contact 105A for contacting, and thus detecting, the cover 103 when the cover is in the first position C1. The aerosol provision device 4 in this embodiment then comprises a second contact 105B for contacting, and thus detecting, the cover 103 when the cover is in the second position C2. It will be appreciated that other embodiments of detecting circuitry could be employed as required, for instance by using a capacitive or inductive type circuit whereby a portion/component from the cover may be moved, and thus sensed using the capacitive or inductive type circuit to determine the relative position of the portion/component from the cover 103, such to determine whether the cover 103 is in the first position C1 or the second position C2.

From the foregoing therefore, it may be seen that there is provided an effective form of aerosol provision system whereby an operation of a portion 79 of the aerosol provision system and/or aerosol provision device may be controlled based on the determined position of a cover 103 from the aerosol provision device 4. Accordingly described therefore is an aerosol provision system 1 for generating an aerosol, wherein the aerosol provision system 1 comprises a consumable 2, and an aerosol provision device 4 which is configured to receive the consumable. The aerosol provision device 4 comprises a receptacle 8 for receiving the consumable, and the aerosol provision system 1 comprises a cover 103 which is moveable between: a first position C1 in which the cover 103 at least partially covers a first end 9 of the receptacle 8 for inhibiting the consumable 2 from being inserted into the receptacle 8; and a second position C2 in which the cover 103 at least partially exposes the first end 9 for allowing the consumable 2 to be received by the aerosol provision device4 in the receptacle 8. The aerosol provision system further comprises a (first) portion 79 whose operation is configured to be controlled by the aerosol provision system, wherein the aerosol provision system is configured to determine that the cover 103 has moved from the first position C1 to the second position C2; and operate the (first) portion 79 in response to determining that the cover 103 has moved to the second position C2.

Moving away from the cover 103, and returning to the provision of any employed sensor 101 for use in determining, by the aerosol provision device, a predetermined property of the consumable, it will be appreciated in accordance with some embodiments that the sensor 103 may in some embodiments be coupled with any provided control circuitry 18 from the aerosol provision device 4 and/or the aerosol provision system 1, to facilitate the determination process. For instance, and as shown in the embodiments of FIGS. 7-10B, in accordance with some embodiments, the aerosol provision system 1 may comprise control circuitry 18 which is configured to receive the sensor data from the sensor 103, and use the sensor data to determine the predetermined property of the consumable 2.

Following a determination of the predetermined property of the consumable 2, appropriate action may then be taken to cater for the particular property which is determined. For instance, and in accordance with some embodiments, in response to determining the predetermined property of the consumable 2, the control circuitry 18 and/or the aerosol provision device 4 or aerosol provision system 1 more generally, may be configured to control an operation of the aerosol generator 40, such as to supply power to the aerosol generator; vary/increase/decrease the power supplied to the aerosol generator (e.g. to cater for a particular predetermined flavour of aerosol generating material detected in the consumable using the sensor 101); and/or be configured to vary/increase/decrease a rate of aerosol generation from the aerosol provision system (e.g. to cater for a predetermined low or high level of remaining aerosol generating material detected in the consumable using the sensor 101).

As noted previously, and where the sensor 101 is employed, a particular embodiment of operation may comprise the aerosol provision system 1 (or device 4) being configured to prevent the operation of an aerosol generator 40 from the aerosol provision system (device) until the aerosol provision system (device) has determined the predetermined property of the consumable. This functionality may thus act as a safety feature, to better prevent any inadvertent operation of the aerosol generator in instances when this would be inappropriate (e.g. because there is detected a predetermined low amount of remaining aerosol generating material in the consumable, and/or because there is detected an unauthorised/counterfeit consumable, and/or more simply because there is no consumable detected at all).

Appreciating the foregoing therefore, there has accordingly been described an aerosol provision system for generating an aerosol, wherein the aerosol provision system comprises a consumable, and an aerosol provision device which is configured to receive the consumable;
a. wherein the aerosol provision device comprises an optical sensor for sensing a portion of the consumable when the consumable is received by the aerosol provision device, wherein the portion comprises an external surface of the consumable; and
b. wherein the sensor is configured to output sensor data, and the aerosol provision device is configured to use the sensor data to determine a predetermined property of the consumable.

There has also been described a consumable for use in an aerosol provision system for generating an aerosol, wherein the consumable comprises an external surface portion which is configured to be received in a receptacle of an aerosol provision device when the consumable is in use for generating an aerosol, wherein the external surface portion comprises an indicia which is configured to be sensed for determining a predetermined property of the consumable.

There has also been described a method of determining a predetermined property of a consumable in an aerosol provision system, the method comprising:
a. receiving a consumable in an aerosol provision device from the aerosol provision system;
b. sensing, using a sensor from the aerosol provision device, a portion of the consumable when the consumable is received by the aerosol provision device, wherein the portion comprises an external surface of the consumable;
c. outputting sensor data from the sensor; and
d. determining, by the aerosol provision device, a predetermined property of the consumable using the sensor data.

There has also been described an aerosol provision system for generating an aerosol, wherein the aerosol provision system comprises a consumable, and an aerosol provision device which is configured to receive the consumable;
a. wherein the aerosol provision device comprises a receptacle for receiving the consumable; and
b. wherein the aerosol provision system comprises a cover which is moveable between:
i. a first position in which cover at least partially covers a first end of the receptacle for inhibiting the consumable from being inserted into the receptacle and
ii. a second position in which the cover at least partially exposes the first end for allowing the consumable to be received by the aerosol provision device in the receptacle; and
c. wherein the aerosol provision system further comprises a first portion whose operation is configured to be controlled by the aerosol provision system, wherein the aerosol provision system is configured to:
i. determine that the cover has moved from the first position to the second position; and
ii. operate the first portion of the aerosol provision system in response to determining that the cover has moved to the second position.

There has also been described an aerosol provision device for an aerosol provision system for generating an aerosol, wherein the aerosol provision device comprises:
a. a receptacle for receiving the consumable;
b. a cover which is moveable between:
i. a first position in which the cover at least partially exposes the first end of the receptacle for inhibiting the consumable from being inserted into receptacle; and
ii. a second position in which the cover at least partially exposes the first end for allowing the consumable to be received by the aerosol provision device in the receptacle; and
c. a first portion whose operation is configured to be controlled by the aerosol provision device, wherein the aerosol provision device is configured to:
i. determine that the cover has moved from the first position to the second position; and
ii. operate the first portion of the aerosol provision device in response to determining that the cover has moved to the second position.

There has also been described a method of controlling the operation of a portion of an aerosol provision system, wherein the aerosol provision system comprises a consumable and an aerosol provision device, wherein the aerosol provision device comprises a receptacle for receiving the consumable, and wherein the method comprises:
a. moving a cover, from the aerosol provision system, from a first position in which the cover at least partially covers a first end of the receptacle and inhibits the consumable from being inserted into the receptacle, to a second position in which the cover at least partially exposes the first end for allowing the consumable to be received by the aerosol provision device inside the receptacle;
b. determining that the cover has moved to the second position; and
c. operating the first portion of the aerosol provision system in response to determining that the cover has moved to the second position.

Bearing this in mind, the above noted disclosures may thus appreciably relate to the additional embodiments as set out in the following numbered clauses at the end of this specification, alongside the other noted embodiments from the below noted claims.

There has also been described an aerosol provision system 1 comprising a consumable 2, and an aerosol provision device 4 which is configured to receive the consumable 2. The aerosol provision device 4 comprises a receptacle 8 for receiving the consumable. Also provided is a cover 103 which is moveable between a first, closed, position C1 in which the cover 103 at least partially covers the receptacle 8, and a second, open, position C2 in which the cover at least partially exposes the receptacle 8. A first portion 79, such as a light source 81 or an aerosol generator 40, or a sensor 101, is configured to be controlled in response to there being a determination that the cover has moved to the second position C2. In this way, the first portion 79 may be operated in response to the cover 103 is determined as having been opened, to save power in the aerosol provision system 1 by not operating the portion 79 beforehand.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims (or any herein recited dependent clauses) may be combined with features of the independent claims (or independent clauses) in combinations other than those explicitly set out in the claims or clauses. The disclosure may include other inventions not presently claimed, but which may be claimed in future. Accordingly, any permutation of the features from the claims may be combined as required, and/or may be combined with any permutation of the features from the herein recited clauses at the end of this specification.

### CONSISTORY SET OF CLAUSES

1. An aerosol provision system for generating an aerosol, wherein the aerosol provision system comprises a consumable, and an aerosol provision device which is configured to receive the consumable;
wherein the aerosol provision device comprises an optical sensor for sensing a portion of the consumable when the consumable is received by the aerosol provision device, wherein the portion comprises an external surface of the consumable; and
wherein the sensor is configured to output sensor data, and the aerosol provision device is configured to use the sensor data to determine a predetermined property of the consumable.

2. An aerosol provision system according to clause 1, wherein the aerosol provision device comprises a receptacle which is configured to receive the consumable.

3. An aerosol provision system according to clause 2, wherein the receptacle is configured to fully encapsulate the consumable when the consumable is received by the aerosol provision device.

4. An aerosol provision system according to any of clauses 2-3, wherein the receptacle comprises:
a first end for inserting the consumable into the receptacle;
a second end opposite the first end; and
a side wall between the first end and the second end.

5. An aerosol provision system according to clause 4, wherein the sensor is recessed into the side wall.

6. An aerosol provision system according to clause 4 or 5, wherein the sensor is recessed into the second end.

7. An aerosol provision system according to any of clauses 4-6, wherein the aerosol provision system further comprises:
a cover which is moveable between:
a first position in which the cover at least partially covers the first end and inhibits the consumable from being inserted into the receptacle; and
a second position in which the cover at least partially exposes the first end for allowing the consumable to be received by the aerosol provision device.

8. An aerosol provision system according to clause 7, wherein the cover is detachable from the aerosol provision device.

9. An aerosol provision system according to clause 7, wherein the aerosol provision device comprises the cover.

10. An aerosol provision system according to clause 9, wherein the cover is slideable from the first position to the second position.

11. An aerosol provision system according to any of clauses 7-10, wherein the aerosol provision device is configured to control an operation of the sensor in response to determining that the cover has moved between the first position and the second position.

12. An aerosol provision system according to any of clauses 7-11, wherein the aerosol provision device is configured to operate the optical sensor in response to the cover being located in the second position.

13. An aerosol provision system according to any of clauses 7-12, wherein the aerosol provision device is configured to operate the optical sensor whilst the cover is in the second position.

14. An aerosol provision system according to any of clauses 7-13, wherein the aerosol provision device is configured to disable the optical sensor in response to the cover being located in the first position.

15. An aerosol provision system according to any of clauses 7-14, wherein the aerosol provision device is configured to disable the optical sensor whilst the cover is in the first position.

16. An aerosol provision system according to any of clauses 7-15, wherein the sensor is located at the side wall.

17. An aerosol provision system according to any of clauses 7-16, wherein the sensor is located at the second end.

18. An aerosol provision system according to any of clauses 4-17, wherein the sensor is located no more than 30mm from the second end.

19. An aerosol provision system according to any of clauses 2-18, wherein the sensor is located in the receptacle.

20. An aerosol provision system according to any of clauses 2-19, wherein the receptacle is substantially cylindrical.

21. An aerosol provision system according to any of clauses 2-20, wherein the portion of the consumable is configured to be located in the receptacle when the consumable is received by the aerosol provision device.

22. An aerosol provision system according to any of clauses 2-21, wherein the aerosol provision device comprises at least one retaining portion for gripping the consumable received in the receptacle.

23. An aerosol provision system according to clause 22, wherein the at least one retaining portion comprises a plurality of retaining portions for gripping the consumable received in the receptacle.

24. An aerosol provision system according to clause 23, wherein the sensor is located between the plurality of retaining portions.

25. An aerosol provision system according to clause 23 or 24, wherein each retaining portion projects into the receptacle.

26. An aerosol provision system according to any of clauses 22-25, when further dependent on clause 4 at least, wherein each retaining portion projects from the side wall of the receptacle.

27. An aerosol provision system according to any of clauses 22-26, when further dependent on clause 4 at least, wherein each retaining portion extends between the first end and the second end of the receptacle.

28. An aerosol provision system according to any preceding clause, wherein the portion comprises an indicia.

29. An aerosol provision system according to any preceding clause, wherein the portion comprises a pattern.

30. An aerosol provision system according to any preceding clause, wherein the portion comprises a maximum dimension which is no more than 30mm.

31. An aerosol provision system according to any preceding clause, wherein the portion comprises a maximum dimension which is no more than 20mm.

32. An aerosol provision system according to any preceding clause, wherein the portion comprises a maximum dimension which is no more than 10mm.

33. An aerosol provision system according to any preceding clause, wherein the portion is machine readable.

34. A consumable according to any preceding clause, wherein the portion comprises a label which is attached to the consumable.

35. An aerosol provision system according to any preceding clause, wherein the optical sensor comprises a camera.

36. An aerosol provision system according to any preceding clause, wherein the predetermined property comprises a composition of aerosol generating material inside the consumable.

37. An aerosol provision system according to any preceding clause, wherein the predetermined property comprises a remaining amount of aerosol generating material inside the consumable.

38. An aerosol provision system according to any preceding clause, wherein the predetermined property comprises an indication on whether the consumable is authorised.

39. An aerosol provision system according to any preceding clause, wherein the aerosol provision system comprises control circuitry which is configured to:
receive the sensor data from the sensor; and
use the sensor data to determine the predetermined property of the consumable.

40. An aerosol provision system according to clause 39, wherein the aerosol provision system further comprises an aerosol generator for generating the aerosol, and wherein the control circuitry is further configured to:
control an operation of the aerosol generator in response to determining the predetermined property of the consumable.

41. An aerosol provision system according to any preceding clause, wherein the aerosol provision system is configured to prevent the operation of an aerosol generator from the aerosol provision system until the aerosol provision device has determined the predetermined property of the consumable.

42. An aerosol provision device for an aerosol provision system for generating an aerosol, wherein the aerosol provision device comprises:
a sensor for sensing an external surface portion of a consumable which is configured to be received by the aerosol provision device;
wherein the sensor is configured to output sensor data and the aerosol provision device is configured to use the sensor data to determine a predetermined property of the consumable.

43. An aerosol provision device according to clause 42, wherein the aerosol provision device is configured to prevent the operation of an aerosol generator from the aerosol provision device until the aerosol provision device has determined the predetermined property of the consumable.

44. A consumable for use in an aerosol provision system for generating an aerosol, wherein the consumable comprises an external surface portion which is configured to be received in a receptacle of an aerosol provision device when the consumable is in use for generating an aerosol, wherein the external surface portion comprises an indicia which is configured to be sensed for determining a predetermined property of the consumable.

45. A consumable according to clause 44, wherein the consumable comprises a body portion, and a mouthpiece portion, wherein the body portion comprises the indicia.

46. A consumable according to clause 44 or 45, wherein the external surface portion comprises a label which is attached to the consumable.

47. A consumable according to any of clauses 44-46, wherein the external surface portion is configured to be machine readable.

48. A consumable according to any of clauses 44-47, wherein the consumable comprises an aerosol generator for aerosolising aerosol-generating material.

49. A consumable according to any of clauses 44-48, wherein the consumable is substantially cylindrical.

50. A consumable according to any of clauses 44-49, wherein the consumable comprises a reservoir for aerosol-generating material which is configured to be aerosolised to generate the aerosol.

51. A consumable according to any of clauses 44-50, wherein the consumable comprises a heating element which is configured to be heated for generating the aerosol.

52. A consumable according to clause 51, wherein the heating element comprises a susceptor.

53. A method of determining a predetermined property of a consumable in an aerosol provision system, the method comprising:
receiving a consumable in an aerosol provision device from the aerosol provision system;
sensing, using a sensor from the aerosol provision device, a portion of the consumable when the consumable is received by the aerosol provision device, wherein the portion comprises an external surface of the consumable;
outputting sensor data from the sensor; and
determining, by the aerosol provision device, a predetermined property of the consumable using the sensor data.

54. A method according to clause 53, wherein the method further comprises control circuitry from the aerosol provision device:
receiving the sensor data which is output from the sensor; and
determining the predetermined property of the consumable using the sensor data.

55. A method according to clause 53 or 54, wherein the method further comprises:
controlling an operation of the aerosol generator in response to determining the predetermined property of the consumable.

56. A method according to any of clauses 53-55,
wherein receiving a consumable in an aerosol provision device from the aerosol provision system further comprises receiving the consumable in a receptacle of the aerosol provision device;
wherein the portion of the consumable is located in the receptacle.

57. A method according to any of clauses 53-56, wherein the method further comprises:
preventing the operation of an aerosol generator from the aerosol provision device until the aerosol provision system has determined the predetermined property of the consumable.

1. An aerosol provision device comprising:
a substantially cylindrical receptacle for receiving a substantially cylindrical consumable, wherein the receptacle comprises:
a first end for receiving the consumable into the receptacle;
a second end opposite the first end; and
a side wall between the first end and the second end;
a coil which is configured to inductively heat a susceptor located in the consumable;
an optical sensor for sensing a portion of the consumable when the consumable is received by the aerosol provision device, wherein the portion comprises an external surface of the consumable; and
a light source located at the side wall of the receptacle,
wherein the sensor is configured to output sensor data, and the aerosol provision device is configured to use the sensor data to determine a predetermined property of the consumable, and to apply a predetermined heating regime based on said predetermined property.

2. The aerosol provision device of claim 1, wherein the predetermined property comprises a composition of aerosol generating material inside the consumable.

3. The aerosol provision device of claim 1, wherein the predetermined property comprises a remaining amount of aerosol generating material inside the consumable.

4. The aerosol provision device of claim 1, wherein the aerosol provision device is configured to prevent the generation of aerosol by the aerosol provision device until the aerosol provision device has determined the predetermined property of the consumable.

5. The aerosol provision device of claim 1, wherein the predetermined property comprises an indication on whether the consumable is authorised.

6. The aerosol provision device of claim 5, wherein the aerosol provision device is configured to prevent the generation of aerosol by the aerosol provision device until the aerosol provision device has determined that the consumable is authorised.

7. The aerosol provision device of claim 1, wherein the optical sensor comprises a camera.

8. The aerosol provision device of claim 1, wherein the sensor is recessed into the side wall.
